(19) United States
(12) Patent Application Publication
(10) Pub. No.: US 2026/0314606 A1
(43) Pub. Date: Oct. 15, 2026

(54) REDUCED SUGAR GLUTEN-FREE BREAD WITH SUCROSE-LIKE TASTE

(71) Applicant: CORN PRODUCTS DEVELOPMENT, INC., WESTCHESTER, IL (US)

(72) Inventors: Didem ICOZ, Bridgewater, NJ (US); Kasi SUNDARESAN, Bridgewater, NJ (US)

(21) Appl. No.: 19/479,062

(22) PCT Filed: Apr. 24, 2024
(86) PCT No.: PCT/US2024/025918

§ 371 Date: Oct. 27, 2025

Related U.S. Application Data
(60) Provisional application No. 63/498,619, filed on Apr. 27, 2023.

(51) Int. Cl. A21D 13/066; A21D 2/18; A21D 13/062

(52) U.S. Cl. CPC A21D 13/066; A21D 2/181; A21D 13/062

(57) ABSTRACT

The present technology provides a low-calorie, gluten-free bread composition that includes a fermentable monosaccharide, disaccharide, or syrup, and a non-fermentable rare sugar, such as allulose. The bread composition can include a high potency sweetener (HPS). The bread composition may be a reduced calorie gluten-free bread composition, which mimics taste and physical properties normally observed in gluten-free bread products having higher fermentable sugar content.

There is a growing demand for gluten-free bakery products, in part from individuals with Celiac disease, gluten sensitivity, and/or individuals who are otherwise health-conscious.

Sugar serves multiple functions in bread. For example, in bread, fermentable bulk sweeteners such as sucrose, high-fructose corn syrup (HFCS), and dextrose are often added to aid in yeast feeding, resulting in a faster rise. High potency sweeteners can be added to bread products to impart sweetness. However, they are often added in very low concentrations, and are insufficient to provide a fermentable substrate to the yeast. Other sweetener tool-box ingredients, such as rare sugars (e.g., allulose) and polyols can provide the bulk and sweetness, but are not fermentable by yeast. Accordingly, there is a pressing need for gluten-free bread products that harbor sweetness and texture characteristics such as those of non-gluten-free bread, but that contain lower sugar content than currently available gluten-free bread products.

The present disclosure addresses these needs by providing a gluten-free bread product composition with similar taste and performance to that appreciated in non-gluten-free bread products. The gluten-free bread products provided herein feature a baked good that has a composition comprising very low concentrations of caloric monosaccharide or disaccharide or low sugar syrup, as well as a rare sugar and a natural high-potency sweetener. The disclosure provides methods of producing a gluten-free bread product having the above-mentioned characteristics, the method involving the use of enzymes to provide a reduced sugar baked product like the full sugar product. Non-limiting examples of enzymes that can be used in accordance with the present disclosure include amylases, proteases, lipases, hemicellulases, and hydrolases.

### BRIEF DESCRIPTION OF THE DRAWINGS

The technology described in this specification can be further understood with reference to the following figures, which are not intended to limit the full scope of the disclosed technologies.

FIG. 1 is photograph of a Volscan instrument securing a loaf of bread in place for volume and specific volume measurement.

FIG. 2A is a panel of photographs showing multiple views of a white bread product produced from a formulation comprising sucrose.

FIG. 2B is a panel of photographs showing multiple views of a white bread product produced from a formulation comprising allulose.

FIG. 3 is a set of photographs showing a cross section of a white bread product produced from a formulation comprising sucrose (left), and a white bread product produced from a formulation comprising allulose.

FIG. 4 is a graph depicting the volume of a white bread product produced from a formulation comprising sucrose and a white bread product produced from a formulation comprising allulose.

FIG. 5 is a graph depicting the firmness of a white bread product produced from a formulation comprising sucrose and a white bread product produced from a formulation comprising allulose.

FIG. 6 is a graph depicting the crumb color of a white bread product produced from a formulation comprising sucrose and a white bread product produced from a formulation comprising allulose. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 7 is a graph depicting the crust color of a white bread product produced from a formulation comprising sucrose and a white bread product produced from a formulation comprising allulose. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 8 is a graph depicting the water activity of a white bread product produced from a formulation comprising sucrose and a white bread product produced from a formulation comprising allulose.

FIG. 9 is a graph depicting the moisture of a white bread product produced from a formulation comprising sucrose and a white bread product produced from a formulation comprising allulose.

FIG. 10 is a graph depicting the firmness shelf life of a white bread product produced from a formulation comprising sucrose and a white bread product produced from a formulation comprising allulose. Firmness measurements are reported as units of force (g).

FIG. 11 is a graph depicting the moisture shelf life of a white bread product produced from a formulation comprising sucrose and a white bread product produced from a formulation comprising allulose.

FIG. 12 is a graph depicting the water activity shelf life of a white bread product produced from a formulation comprising sucrose and a white bread product produced from a formulation comprising allulose.

FIG. 13 is a panel of photographs showing multiple views of a gluten-free bread product produced from a formulation comprising 3.41% sucrose and no allulose (top), a gluten-free bread product produced from a formulation comprising 6.79% allulose and no sucrose (middle), and a gluten-free bread product produced from a formulation comprising 3.41% sucrose and 2.185% allulose (bottom).

FIG. 14 is a graph depicting the volume of a gluten-free bread product produced from a formulation comprising sucrose (left), a gluten-free bread product produced from a formulation comprising allulose and no sucrose (middle), and a gluten-free bread product produced from a formulation comprising both sucrose and allulose (right).

FIG. 15 is a graph depicting the firmness of a gluten-free bread product produced from a formulation comprising sucrose (left), and a gluten-free bread product produced from a formulation comprising both sucrose and allulose (right).

FIG. 16 is a graph depicting the crumb color of a gluten-free bread product produced from a formulation comprising sucrose and a gluten-free bread product produced from a formulation comprising both sucrose and allulose. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 17 is a graph depicting the crust color of a gluten-free bread product produced from a formulation comprising sucrose and a gluten-free bread product produced from a formulation comprising both sucrose and allulose. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 18 is a graph depicting the moisture content of a gluten-free bread product produced from a formulation comprising sucrose and a gluten-free bread product produced from a formulation comprising both sucrose and allulose.

FIG. 19 is a graph depicting the water activity of a gluten-free bread product produced from a formulation comprising sucrose and a gluten-free bread product produced from a formulation comprising both sucrose and allulose.

FIG. 20 is a panel of photographs showing multiple views of a gluten-free bread product produced from a formulation comprising 3.41% sucrose and no allulose, a gluten-free bread product produced from a formulation comprising 1.25% sucrose and 5.09% allulose, a gluten-free bread product produced from a formulation comprising 0.75% sucrose and 5.74% allulose, and a gluten-free bread product produced from a formulation comprising 0.5% sucrose and 6.08% allulose, as indicated.

FIG. 21 is a set of photographs showing a cross section of a gluten-free bread product produced from a formulation comprising sucrose and no allulose (“Control,” top left), and gluten-free bread product produced from formulations comprising allulose and various concentrations of sucrose, as indicated.

FIG. 22 is a graph depicting the volume of gluten-free bread products produced from formulations comprising sucrose at 3.41% (Control), or various lower amounts of sucrose in the presence of allulose, as indicated.

FIG. 23 is a graph depicting the firmness of gluten-free bread products produced from formulations comprising sucrose at 3.41% (Control), or various lower amounts of sucrose in the presence of allulose, as indicated.

FIG. 24 is a graph depicting the crumb color of gluten-free bread products produced from formulations comprising sucrose at 3.41% (Control), or various lower amounts of sucrose in the presence of allulose, as indicated. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 25 is a graph depicting the crust color of gluten-free bread products produced from formulations comprising sucrose at 3.41% (Control), or various lower amounts of sucrose in the presence of allulose, as indicated. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 26 is a graph depicting the moisture content of a gluten-free bread product produced from a formulation comprising sucrose at 3.41% and no allulose (Control), and a gluten-free bread product produced from a formulation comprising sucrose at 0.75% and allulose at 5.74%.

FIG. 27 is a graph depicting the water activity of a gluten-free bread product produced from a formulation comprising sucrose at 3.41% and no allulose (Control), and a gluten-free bread product produced from a formulation comprising sucrose at 0.75% and allulose at 5.74%.

FIG. 28 is a panel of photographs showing multiple views of a gluten-free bread product produced from a formulation comprising 1.25% sucrose and 5.09% allulose (top), a gluten-free bread product produced from a formulation comprising 1.25% dextrose and 5.09% allulose, and a gluten-free bread product produced from a formulation comprising 1.25% high-fructose corn syrup (HFCS) and 5.09% allulose, as indicated.

FIG. 29 is a set of photographs showing a cross section of a gluten-free bread product produced from a formulation comprising 1.25% sucrose and 5.09% allulose (left), a gluten-free bread product produced from a formulation comprising 1.25% dextrose and 5.09% allulose (middle, and a gluten-free bread product produced from a formulation comprising 1.25% high-fructose corn syrup (HFCS) and 5.09% allulose (left).

FIG. 30 is a graph depicting the volume of gluten-free bread products produced from formulations comprising 5.09% allulose and 1.25% of either sucrose, dextrose, or HFCS, as indicated.

FIG. 31 is a graph depicting the firmness at day 7 of gluten-free bread products produced from formulations comprising 5.09% allulose and 1.25% of either sucrose, dextrose, or HFCS, as indicated.

FIG. 32 is a graph depicting the crumb color of gluten-free bread products produced from formulations comprising 5.09% allulose and 1.25% of either sucrose, dextrose, or HFCS, as indicated. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 33 is a graph depicting the crust color of gluten-free bread products produced from formulations comprising 5.09% allulose and 1.25% of either sucrose, dextrose, or HFCS, as indicated. Color value descriptions: L—The higher the value, the lighter the color. The lower the value, the darker the color. 100 is white, and 0 is black; a—positive values indicate more red color, and negative values indicate more green color; b—positive values indicate more blue color, and negative values indicate more yellow color.

FIG. 34 is a graph depicting the moisture content of gluten-free bread products produced from formulations comprising 5.09% allulose and 1.25% of either sucrose, dextrose, or HFCS, as indicated.

FIG. 35 is a graph depicting the water activity of gluten-free bread products produced from formulations comprising 5.09% allulose and 1.25% of either sucrose, dextrose, or HFCS, as indicated.

In one aspect, the present disclosure provides A gluten-free bread product comprising: gluten-free flour; about 0.5 wt % to about 10 wt % of a rare sugar; and about 0.5 wt % to about 2 wt % of a fermentable monosaccharide or disaccharide, or syrup.

In some embodiments, the gluten-free flour comprises non-fermentable gluten-free starches.

In some embodiments, the rare sugar is selected from the group consisting of allulose, tagatose, sorbose, apiose, allose, altrose, melezitose, L-ribose, L-fucose, L-arabinose, D-turanose, and D-leucrose.

In some embodiments, the rare sugar is allulose.

In some embodiments, the rare sugar is present at a concentration of about 5 wt %.

In some embodiments, the fermentable monosaccharide or disaccharide, or syrup is selected from the group consisting of sucrose, dextrose, and high-fructose corn syrup.

In some embodiments, the fermentable monosaccharide or disaccharide, or syrup is sucrose.

In some embodiments, the fermentable monosaccharide or disaccharide, or syrup is present at a concentration of about 1.25 wt %.

In some embodiments, the bread composition may further comprise one or more of psyllium husk, egg white, salt, hydroxypropyl methylcellulose (HPMC), canola oil, yeast, and water.

In some embodiments, the bread composition may further comprise a high potency sweetener (HPS). In some embodiments, the HPS is present at a concentration of about 10 ppm to about 2000 ppm.

In some embodiments, the present technology provides a bread composition (e.g., a gluten-free bread product) that includes about 0.005 wt % to about 0.06 wt % of a high potency sweetener (HPS) and about 1 wt % to about 8 wt % of a rare sugar. Thus, the bread composition may contain about 0.005 wt %, about 0.01 wt %, about 0.015 wt %, about 0.02 wt %, about 0.025 wt %, about 0.03 wt %, about 0.035 wt %, about 0.04 wt %, about 0.045 wt %, about 0.05 wt %, about 0.055 wt %, or about 0.06 wt % of a HPS and about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, or about 8 wt % of a rare sugar. In some embodiments, the rare sugar may include allulose, tagatose, sorbose, apiose, allose, altrose, melezitose, L-ribose, L-fucose, L-arabinose, D-turanose, D-leucrose, or a combination of two or more thereof. In some embodiments, rare sugar may include allulose, tagatose, sorbose, apiose, allose, altrose, melezitose, or a combination of two or more thereof. In some embodiments, the rare sugar may include allulose, tagatose, sorbose, apiose, allose, altrose, melezitose, or a combination of two or more thereof. In some embodiments, the rare sugar may include allulose. In some embodiments, the HPS may comprise an isolate or derivative of a Stevia plant (including S. eupatoria, S. ovata, S plummerae, S. rebaudiana, S. salicifolia, S. serrata, and/or S. rebaudiana), saccharin, aspartame, acesulfame potassium, sucralose, neotame, advantame, those derived from Siraitia grosvenorii, or a combination of two or more thereof.

In some embodiments, the composition may include about 1.5 wt % to 7 wt % of the rare sugar. In some embodiments, the composition may include about 2 wt % to 6 wt % of the rare sugar. In some embodiments, the composition may include about 3 wt % to 5 wt % of the rare sugar. In some embodiments, the composition may include the rare sugar at about 5 wt %. In some embodiments, the rare sugar is allulose. Thus, the composition about include about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, or about 7 wt % of a rare sugar. In some embodiments, the composition about include about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, or about 7 wt % of allulose.

In some embodiments, the composition may include water. In some embodiments, the composition may include at least about 25 wt % water. In some embodiments, the composition may include at least about 30 wt % water. In some embodiments, the composition may include at least about 35 wt % water. In some embodiments, the composition may include about 40 wt % to about 50 wt % water. In some embodiments, the composition may include about 40 wt % water. In other words, the composition may include about 25%, about 30%, about 35%, about 40%, about 45%, about 50% or more water.

In some embodiments, the composition may include a high potency sweetener (HPS). In some embodiments, the HPS is present at a concentration of about 10 ppm to about 2000 ppm. In some embodiments, the HPS is present at a concentration of about 50 ppm to about 1500 ppm. In some embodiments, the HPS is present at a concentration of about 100 ppm to about 1250 ppm. In some embodiments, the HPS is present at a concentration of about 150 ppm to about 1000 ppm. In some embodiments, the HPS is present at a concentration of about 200 ppm to about 1000 ppm. In some embodiments, the HPS is present at a concentration of about 500 ppm to about 1000 ppm. In other words, the concentration of the HPS may be about 10, about 50, about 100, about 150, about 200, about 250, about 300, about 350, about 400, about 450, about 500, about 550, about 600, about 650, about 700, about 750, about 800, about 850, about 900, about 950, about 1000, about 1050, about 1100, about 1150, about 1200, about 1250, about 1300, about 1350, about 1400, about 1450, about 1500, about 1550, about 1600, about 1650, about 1700, about 1750, about 1800, about 1850, about 1900, about 1950, or about 2000 ppm.

In some embodiments, the composition may include about 0.5 wt % to about 10 wt % of a rare sugar, and 2 wt % or less of a fermentable monosaccharide or disaccharide, or syrup. In some embodiments, the composition may include about 1 wt % to about 8 wt % of a rare sugar, and 0.5 wt % to about 2 wt % of a fermentable monosaccharide or disaccharide, or syrup. In some embodiments, the monosaccharide or disaccharide, or syrup is present at a concentration of less than 2 wt %, less than 1.9 wt %, less than 1.8 wt %, less than 1.7 wt %, less than 1.6 wt %, less than 1.5 wt %, less than 1.4 wt %, less than 1.3 wt %, less than 1.2 wt %, less than 1.1 wt %, less than 1 wt %, less than 0.9 wt %, less than 0.8 wt %, less than 0.7 wt %, less than 0.6 wt %, or less than 0.5 wt %. In some embodiments, the monosaccharide or disaccharide, or syrup is present at a concentration of about 1.25 wt %. In some embodiments, the rare sugar is present at a concentration of about 5 wt %, and the monosaccharide or disaccharide, or syrup is present at a concentration of about 1.25 wt %. The fermentable monosaccharide or disaccharide, or syrup can include, without limitation, sucrose, dextrose, or high-fructose corn syrup (HFCS).

In some embodiments, a gluten-free bread product of the present disclosure can include one or more additional elements necessary to ensure that the bread product can be produced using known methods. In some embodiments, the composition can include one or more of psyllium husk, egg white, salt, dietary fiber, canola oil, yeast, and water. Dietary fiber can include, without limitation, hydroxypropyl methylcellulose (HPMC), which is a non-fermentable, semi-synthetic dietary fiber based on cellulose.

In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, and water. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, and water, wherein the rare sugar is present at a concentration of about 2 wt % to about 8 wt %, and wherein the fermentable monosaccharide or disaccharide or syrup is present at a concentration of less than about 2 wt %. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, and water, wherein the rare sugar is present at a concentration of about 2 wt % to about 8 wt %, and wherein the fermentable monosaccharide or disaccharide or syrup is present at a concentration of about 0.5 wt % to about 2 wt %. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, and water, wherein the rare sugar is present at a concentration of about 5 wt %, and wherein the fermentable monosaccharide or disaccharide or syrup is present at a concentration of about 1.25 wt %.

In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, a high potency sweetener (HPS), and water. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, high potency sweetener (HPS), and water, wherein the rare sugar is present at a concentration of about 2 wt % to about 8 wt %, and wherein the fermentable monosaccharide or disaccharide or syrup is present at a concentration of less than about 2 wt %. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, high potency sweetener (HPS), and water, wherein the rare sugar is present at a concentration of about 2 wt % to about 8 wt %, and wherein the fermentable monosaccharide or disaccharide or syrup is present at a concentration of about 0.5 wt % to about 2 wt %. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, high potency sweetener (HPS), and water, wherein the rare sugar is present at a concentration of about 5 wt %, and wherein the fermentable monosaccharide or disaccharide or syrup is present at a concentration of about 1.25 wt %. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, high potency sweetener (HPS), and water, wherein the rare sugar is present at a concentration of about 2 wt % to about 8 wt %, wherein the fermentable monosaccharide or disaccharide or syrup is present at a concentration of about 0.5 wt % to about 2 wt %, and wherein the HPMC is present at a concentration of about 10 ppm to about 2000 ppm. In some embodiments, a gluten-free bread composition comprises, consists of, or consists essentially of gluten-free flour, a fermentable monosaccharide or disaccharide or syrup (e.g., sucrose, dextrose, or high fructose corn syrup), a non-fermentable rare sugar (e.g., allulose), psyllium husk, egg white, salt, dietary fiber (e.g., HPMC), oil (e.g., canola oil), yeast, high potency sweetener (HPS), and water, wherein the rare sugar is present at a concentration of about 5 wt %, wherein the fermentable monosaccharide or disaccharide or syrup is present at a concentration of about 1.25 wt %, and wherein the HPMC is present at a concentration of about 10 ppm to about 2000 ppm.

In some embodiments, the composition may exhibit substantially the same taste or the same taste as an equivalent full-calorie bread composition. In some embodiments, the composition may exhibit substantially the same appearance time and extension time or the same appearance time and extension time as an equivalent full-calorie bread composition. In some embodiments, the composition may exhibit substantially the same sweetness adaption or the same sweetness adaption as an equivalent full-calorie bread composition. In some embodiments, the composition may exhibit sweetness and mouthfeel that are substantially the same or the same as an equivalent full-calorie bread composition.

The following interpretation guide and definitions are provided to facilitate understanding of technology disclosed in this specification. Note that unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. Although not explicitly defined below, such terms should be interpreted according to their common meaning.

Unless the context indicates otherwise, it is specifically intended that the various features described herein can be used in any combination. Moreover, the disclosure also contemplates that in some embodiments, any feature or combination of features set forth herein can be excluded or omitted. To illustrate, if the specification states that a complex comprises components A, B, and C (or A, B, and/or C), it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and biological equivalents thereof.

As used in the description of the invention and the appended claims, the singular forms “a,” “an” and “the” are intended to include the plural forms as well, unless the context clearly indicates otherwise.

The terms “substantially” and “about” are used herein to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. When referring to a first numerical value as “substantially” or “about” the same as a second numerical value, the terms can refer to the first numerical value being within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. The terms or “acceptable,” “effective,” or “sufficient” when used to describe the selection of any components, ranges, dose forms, etc. disclosed herein intend that said component, range, dose form, etc. is suitable for the disclosed purpose.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Also as used herein, “and/or” refers to and encompasses any and all possible combinations of one or more of the associated listed items, as well as the lack of combinations when interpreted in the alternative (“or”).

As used herein, the term “comprising” is intended to mean that the compositions and methods include the recited elements, but not excluding others. “Consisting essentially of” when used to define compositions and methods, shall mean excluding other elements of any essential significance to the composition or method. “Consisting of” shall mean excluding more than trace elements of other ingredients for claimed compositions and substantial method steps. Examples and implementations defined by each of these transition terms are within the scope of this disclosure. Accordingly, it is intended that the methods and compositions can include additional steps and components (comprising) or alternatively including steps and compositions of no significance (consisting essentially of) or alternatively, intending only the stated method steps or compositions (consisting of).

As used herein, “optional” or “optionally” means that the subsequently described event or circumstance can or cannot occur, and that the description includes instances where the event or circumstance occurs and instances where it does not.

As used herein, “substantially free” refers to less than about 2 wt % of the specified component based on the total weight of the composition. In some embodiments, the composition may include less than about 1 wt %, less than about 0.5 wt %, or less than about 0.1 wt %.

As used herein, “reduced calorie bread composition” refers to a bread product or composition that has at least about 25% less calories than an equivalent full-calorie bread composition. In some embodiments, the reduced calorie bread composition may have at least about 50% less calories than an equivalent full-calorie bread composition. In some embodiments, the reduced calorie bread composition may have at least about 65% less calories than an equivalent full-calorie bread composition. In some embodiments, the reduced calorie bread composition may have at least about 75% less calories than an equivalent full-calorie bread composition. In some embodiments, the reduced calorie bread composition may have at least about 90% less calories than an equivalent full-calorie bread composition. In some embodiments, the reduced calorie bread composition may have a calorie reduction of about 50% to about 100% compared to an equivalent full-calorie bread composition. In some embodiments, the reduced calorie bread composition may have a calorie reduction of about 65% to about 100% compared to an equivalent full-calorie bread composition. In some embodiments, the reduced calorie bread composition may have a calorie reduction of about 75% to about 100% compared to an equivalent full-calorie bread composition.

As used herein, “high potency” or “high intensity” sweetener refers to a sweetener that is sweeter than sucrose, but contributes minimal or no calories when added to foodstuff. In any embodiment, high potency or high intensity sweeteners may be at least about 2-times sweeter than sucrose. In any embodiment, “high potency” or “high intensity” sweeteners may be at about 10-times, at least about 25-times, at about 50-times, at least about 75-times, at least about 100-times, about 125-times, at least about 150-times, at about 175-times, or at least about 200-times sweeter than sucrose. In any embodiment, high potency or high intensity sweeteners may include, but not limited to, those derived from Stevia (including S. eupatoria, S. ovata, S plummerae, S. rebaudiana, S. salicifolia, S. serrata, and/or S. rebaudiana), saccharin, aspartame, acesulfame potassium, sucralose, neotame, advantame, those derived from Siraitia grosvenorii, or a combination of two or more thereof.

As used herein, “rare sugar” refers to a sugar that occurs in limited quantities in nature. Rare sugars may be produced commercially using microbial enzymes. In some embodiments, rare sugars may include, but are not limited to, allulose, tagatose, sorbose, apiose, allose, altrose, melezitose, L-ribose, L-fucose, L-arabinose, D-turanose, D-leucrose, or a combination of two or more thereof. In some embodiments, rare sugar may include allulose, tagatose, sorbose, apiose, allose, altrose, melezitose, or a combination of two or more thereof. Many rare sugars are low-calorie and/or non-fermentable. In some embodiments, a rare sugar may include allulose. In some embodiments, a non-fermentable rare sugar may include allulose.

The technology disclosed in this specification can be further understood with reference to the following aspects, which are not intended to limit the full scope of the disclosed technology in any way.

1. A gluten-free bread product comprising: gluten-free flour; about 0.5 wt % to about 10 wt % of a rare sugar; and about 0.5 wt % to about 2 wt % of a fermentable monosaccharide or disaccharide, or syrup.

2. The gluten-free bread product of claim 1, wherein the gluten-free flour comprises non-fermentable gluten-free starches.

3. The gluten-free bread product of claim 1 or 2, wherein the rare sugar is selected from the group consisting of allulose, tagatose, sorbose, apiose, allose, altrose, melezitose, L-ribose, L-fucose, L-arabinose, D-turanose, and D-leucrose.

4. The gluten-free bread product of any one of claims 1-3, wherein the rare sugar is allulose.

5. The gluten-free bread product of any one of claims 1-4, wherein the rare sugar is present at a concentration of about 5 wt %.

6. The gluten-free bread product of any one of claims 1-5, wherein the fermentable monosaccharide or disaccharide, or syrup is selected from the group consisting of sucrose, dextrose, and high-fructose corn syrup.

7. The gluten-free bread product of any one of claims 1-6, wherein the fermentable monosaccharide or disaccharide, or syrup is sucrose.

8. The gluten-free bread product of any one of claims 1-7, wherein the fermentable monosaccharide or disaccharide, or syrup is present at a concentration of about 1.25 wt %.

9. The gluten-free bread product of any one of claims 1-8, further comprising one or more of psyllium husk, egg white, salt, hydroxypropyl methylcellulose (HPMC), canola oil, yeast, and water.

10. The gluten-free bread product of any one of claims 1-9, further comprising a high potency sweetener (HPS).

11. The gluten-free bread product of claim 10, wherein the HPS is present at a concentration of about 10 ppm to about 2000 ppm.

The technology disclosed in this specification can be further understood with reference to the following examples, which are not intended to limit the full scope of the disclosed technology in any way.

### EXAMPLE 1. BREAD ANALYTICAL PROCEDURE

The present Example describes technologies and protocols for analyzing characteristics of bread.

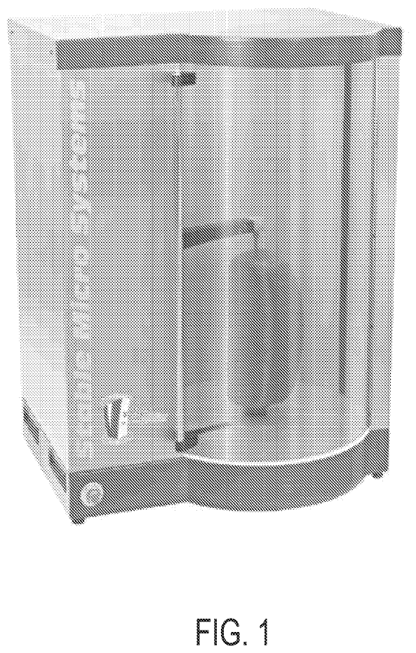

Volscan: Measure the volume and specific volume of the bread loaf. The loaf of bread is held in place by prongs on the top and bottom of the loaf as shown in FIG. 1. A laser then scans and measures the sample. Using the weight of the sample and the results of the scan, the instrument calculates the volume and specific volume of the sample.

Moisture: Moisture is amount of water in a food system not accounting for its availability. Moisture impacts flavor, texture, and mouthfeel. Moisture was measured by using a moisture balance set to 85° C. and auto shutoff. Samples were prepared by chopping a slice of bread in a food processor. Approximately five grams of sample were measured at a time and each batch had two measurements taken.

Water Activity: Water activity is the amount of unbound free water available in a food system. It is an indicator of shelf stability and spoilage. The lower the water activity the less water is available to cause spoilage through moisture migration or growth of microorganisms. Water activity was measured using an Aqua Lab Water Activity Meter. Samples were prepared by chopping the bread in a food processor. Samples were then placed into plastic sample cups covering the bottom of the cup. Samples were placed into the test chamber and the analysis was started. Each sample is measured individually for a total of four tests.

Texture Analysis: In an analysis of bread texture, two slices of bread were placed on the platform and probe TA 11 was used to measure the texture. Two compressions using the same force and distance were used to obtain a texture measurement. Measurements were repeated a total of 6 times with 12 slices of bread. After all slices had been measured, the white pan bread macro was run. The results, which includes quantitative measures of firmness, resilience, cohesiveness, springiness, and chewiness were reported.

C-Cell: Analyze the cell structure, crust thickness, and color of bread slices. Slice bread using the bread slicer shown below. Place bread slices on the c cell tray and add to batch. Analyze 10 slices then process the batch. Record data.

The present Example also describes various definitions used in the analysis of bread products:

Firmness: is the maximum force required to compress the bread during the first compression. Firmness is measured in grams (g). The higher this value the firmer the bread.

Resilience: represents how well the product can regain its original shape. Resilience is calculated by dividing the upstroke energy of the first compression by the down stroke energy of the first compression. Resilience is expressed as a percentage. The higher this value, the higher the resilience of the bread.

Cohesiveness: defines how well the product withstands a second deformation relative to its resistance under a first deformation. Cohesiveness is a consequence of the strength of the internal bonds in the bread. Cohesiveness is calculated as the area of work during the second compression divided by the area of work during the first compression. It is expressed as a percentage. The higher this value, the more cohesive the bread.

Springiness: represents how much the bread physically springs back after it has been deformed during the first compression and has been allowed to wait for the target wait time between strokes. Springiness is calculated as the distance of the detected height during the second compression divided by the original compression distance. Springiness is expressed as a percentage. The higher this value, the springier the bread.

Chewiness: represents the force needed to chew the bread until it is ready to swallow. Chewiness is calculated as Firmness*Springiness. The higher this value, the chewier the bread.

### EXAMPLE 2. COMPARISON OF SUCROSE AND ALLULOSE IN A WHITE BREAD FORMULATION

The present Example illustrates a comparison of bread products comprising sucrose or allulose during the baking process. Unlike sucrose, allulose is a nonfermentable substrate. Yeast typically ferments sucrose during the proofing process. It was hypothesized that, in the absence of sucrose and the presence of allulose, the yeast would utilize the bread flour as the substrate for fermentation during proofing, providing a final bread product with similar characteristics to those observed in sucrose-containing bread.

Control bread formulation (comprising sucrose) and allulose-containing bread formulation were prepared using the ingredients at the indicated amounts shown in Table 1.

TABLE 1
White Bread Formulations

| Ingredients (%) | Control | Allulose |
|---|---|---|
| Flour, Bread | 52.97% | 52.97% |
| Sucrose | 4.24% | 0% |
| Allulose, liquid (74 solids) | 0% | 5.7297% |
| Vegetable Shortening | 2.65% | 2.65% |
| Salt | 1.06% | 1.06% |
| Dough Conditioner | 0.53% | 0.53% |
| Calcium propionate | 0.16% | 0.16% |
| Yeast, instant | 0.79% | 0.79% |
| Water | 37.6% | 36.1103% |
| Total | 100% | 100% |

Control and allulose bread products were prepared using the following protocol: 1. In a kitchen aid bowl with dough hook, blend dry ingredients except yeast. 2. Add tap water (refrigerated approximately 40° F.), yeast, and shortening. 3. Mix 2 minutes at speed 1. 4. Mix 6 minutes at speed 4. Turn over in bowl. Continue to mix at speed 4 for another 6-8 minutes or until dough is developed. 5. Check dough temperature. Desired temperature is 78-80° F. 6. Rest dough, covered, for 5 minutes. 7. Scale at 1000 g per loaf, round, cover, and let rest 5 minutes. 8. Mold and place in pans. 9. Proof at 100° F. for approximately 1 hour and 30 minutes or until dough has risen about 1 inch above the edge of the pan. 10. Bake at 400° F. for 20 minutes. 11. Immediately remove from pans and cool on rack for 1 hour before packaging.

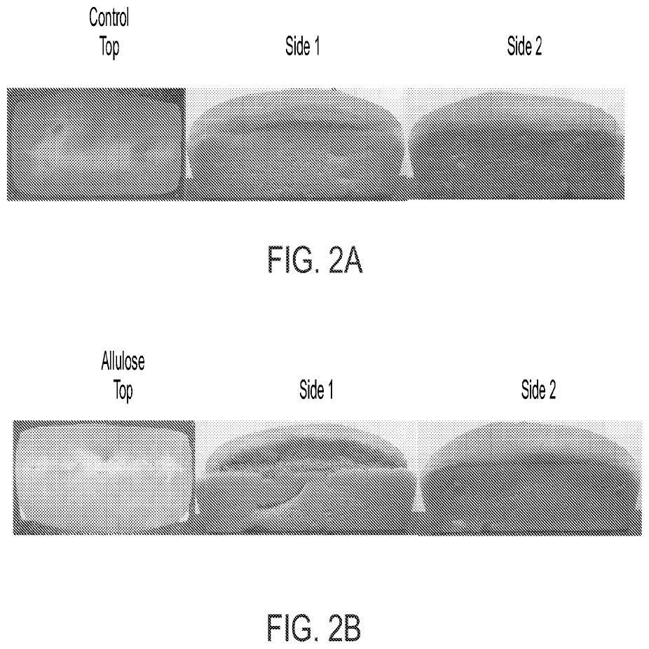

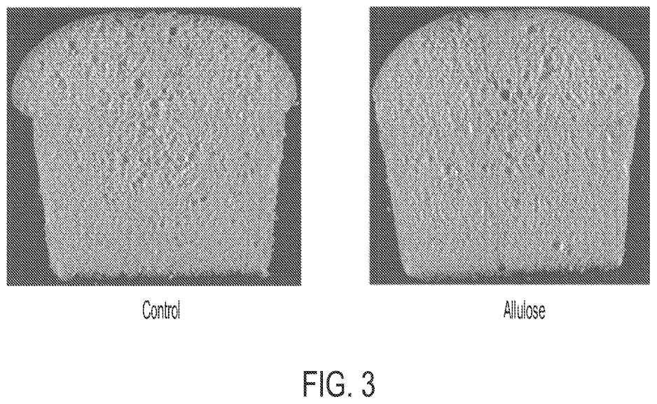

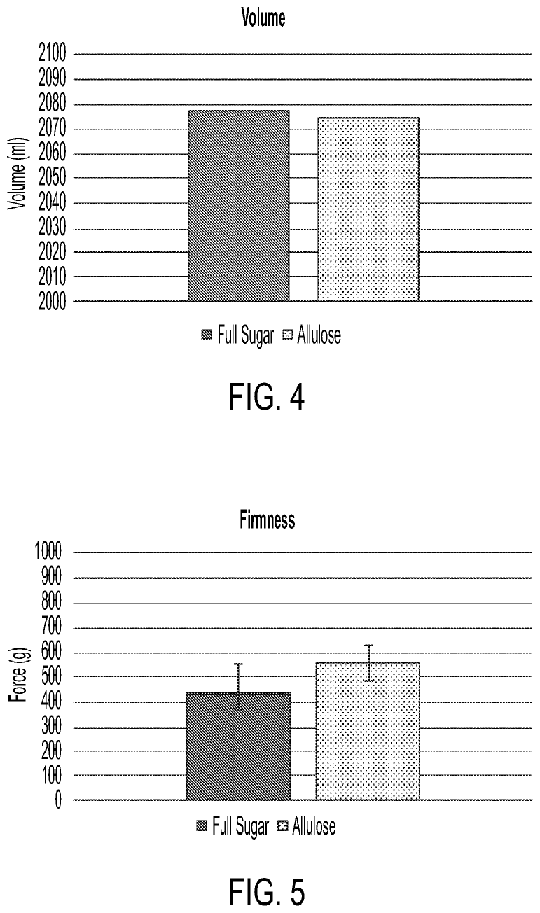

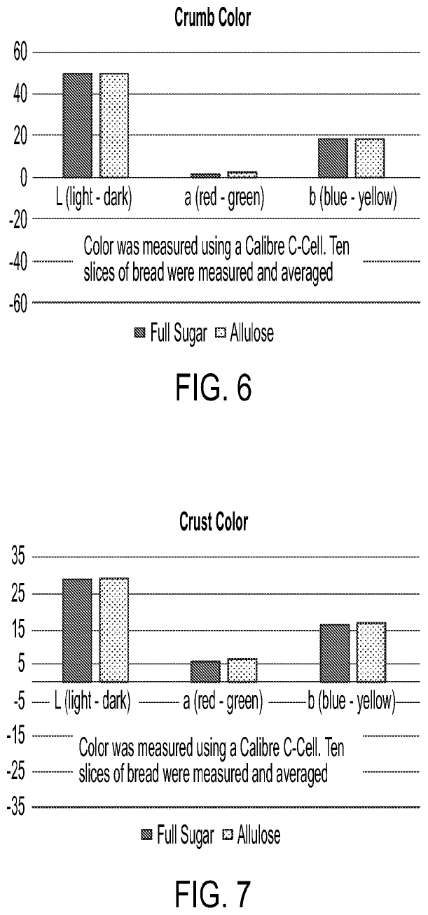

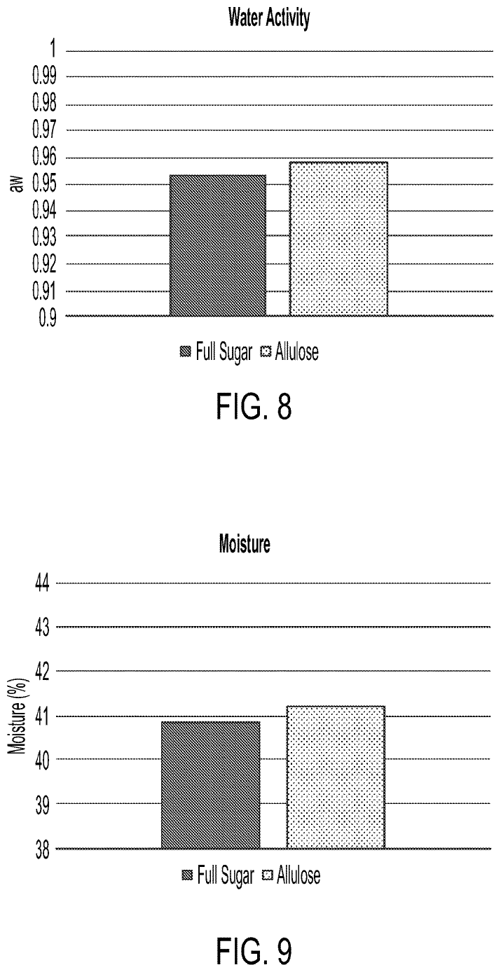

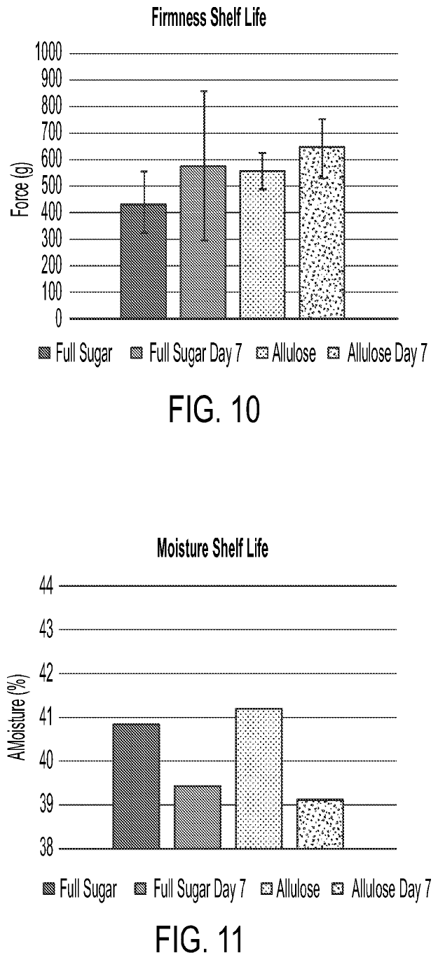

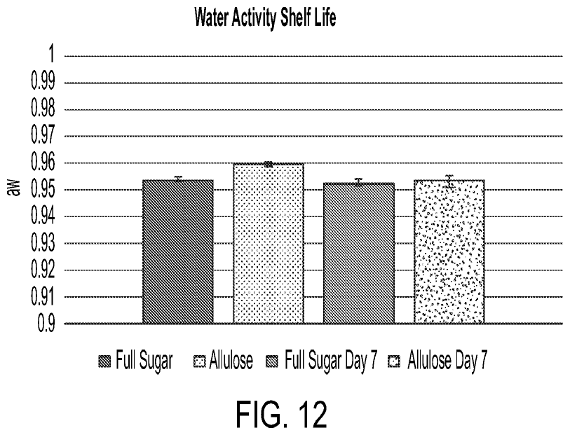

As shown in FIG. 2 and FIG. 3, control and allulose-based bread exhibited similarity in visual appearance. The control and allulose-based breads also displayed similar volume (FIG. 4), firmness (FIG. 5), crumb color (FIG. 6), and crust color (FIG. 7). The allulose-based bread and control bread also exhibited similar water activity (FIG. 8) and moisture content (FIG. 9), although both parameters were slightly higher in the allulose bread. In both samples, firmness increased after one week (FIG. 10), while moisture and water activity decreased after one week (FIG. 11 and FIG. 12, respectively). These results suggest that, in the allulose-based bread, the yeast were able to utilize bread flour as a substrate for fermentation during the proofing process in the absence of sucrose, resulting in a bread product with characteristics similar to those observed in sucrose-based bread.

### EXAMPLE 3. COMPARISON OF SUCROSE AND ALLULOSE IN A GLUTEN-FREE BREAD FORMULATION

The present Example illustrates a comparison of gluten-free bread products comprising sucrose, allulose, or a combination thereof during the baking process. As discussed above, unlike sucrose, allulose is a nonfermentable substrate. Yeast typically ferments sucrose during the proofing process. Gluten-free flour typically comprises predominantly starches that are nonfermentable. It was thus hypothesized that, in the absence of sucrose and the presence of allulose, the yeast would not have access to sufficient fermentable substrate for fermentation during proofing, resulting in a failed final gluten-free bread product.

Control gluten-free bread formulation (comprising sucrose), 100% allulose-containing gluten-free bread formulation, and a gluten-free bread formulation comprising allulose and 3.41% sucrose were prepared using the ingredients at the indicated amounts shown in Table 2.

TABLE 2
Gluten-free bread formulations

| | | 100% SR | Allulose & 3.41% |
|---|---|---|---|
| Ingredients (%) | Control | Allulose | Sucrose |
| PRECISA ® Bake GF | 41.17% | 41.17% | 41.17% |
| Starch* | | | |
| Psyllium Husk | 2.4% | 2.4% | 2.4% |
| Sucrose | 3.41% | 0% | 3.41% |
| Allulose | 0% | 6.79% | 2.185% |
| Egg White Powder | 1.54% | 1.54% | 1.54% |
| Salt | 0.84% | 0.84% | 0.84% |
| HPMC | 1.67% | 1.67% | 1.67% |
| HFCS | 2.1% | 0% | 0% |
| Canola Oil | 5.02% | 5.02% | 5.02% |
| Water | 41.18% | 39.9% | 41.095% |
| Yeast, instant | 0.67% | 0.67% | 0.67% |
| Total | 100% | 100% | 100% |

Precisa ® Bake GF Starch is a gluten free blend of starches useful for baking available from Ingredion Incorporated of Westchester, Illinois

The gluten-free bread products were prepared using the following protocol: 1. Dissolve the syrup into lukewarm water (77° F.) and add yeast and psyllium husk. Slowly add psyllium husk and whisk into water. Allow to sit for 1.5 minutes. 2. Add the dry ingredients and then the oil on top. Mix briefly by hand. 3. Mix at low speed for 2 minutes. 4. Grease bread loaf pans generously; weigh 520 g of dough; mold and place in the baking pans. 5. Proof for 1 hour and 30 minutes to height (½ inch over the tin) at 100° F. 6. Bake at 400° F. for 30 minutes.

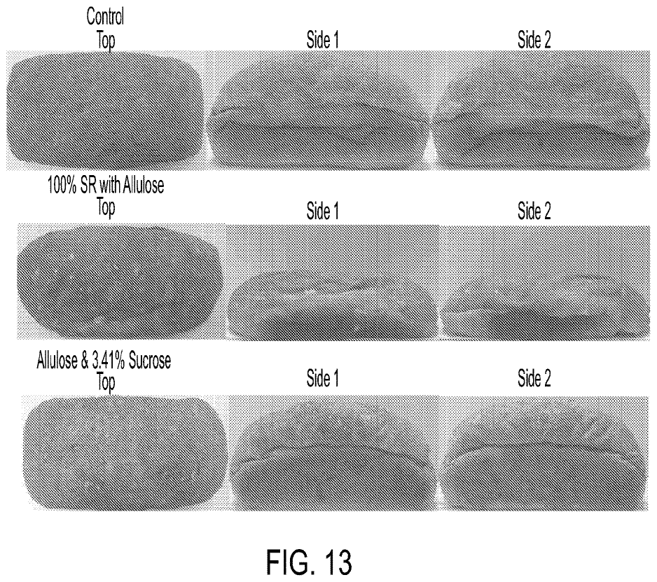

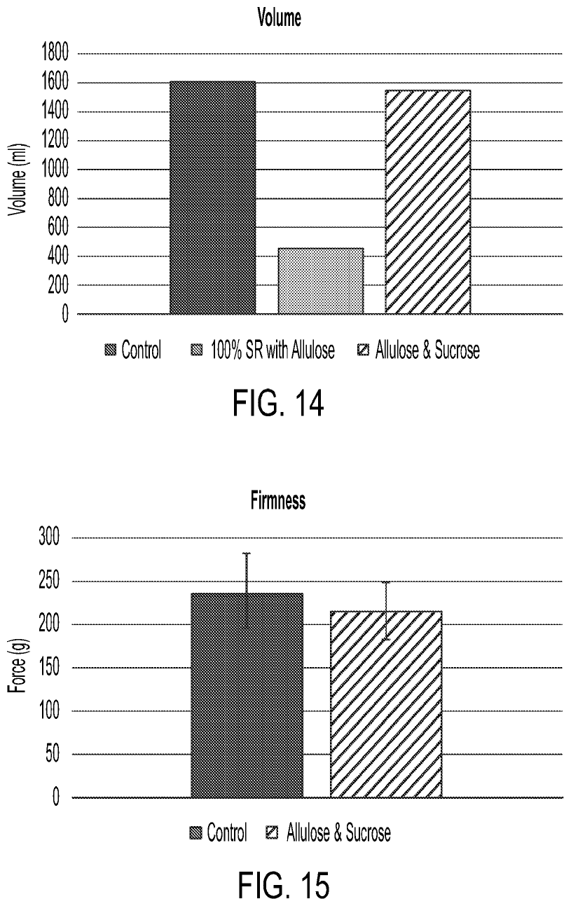

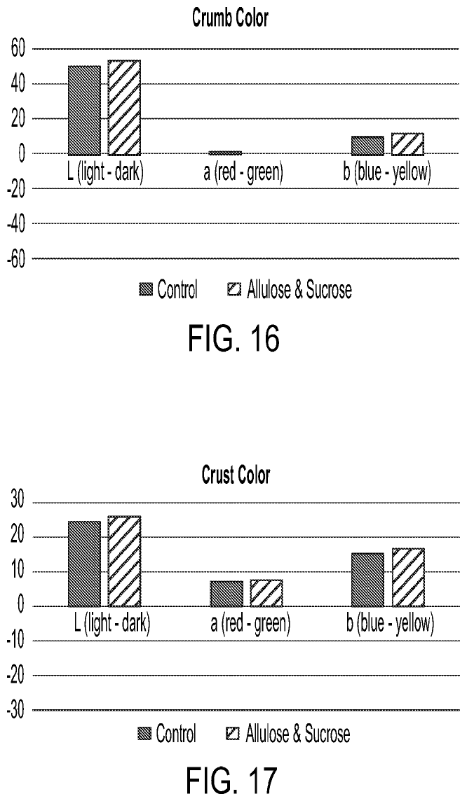

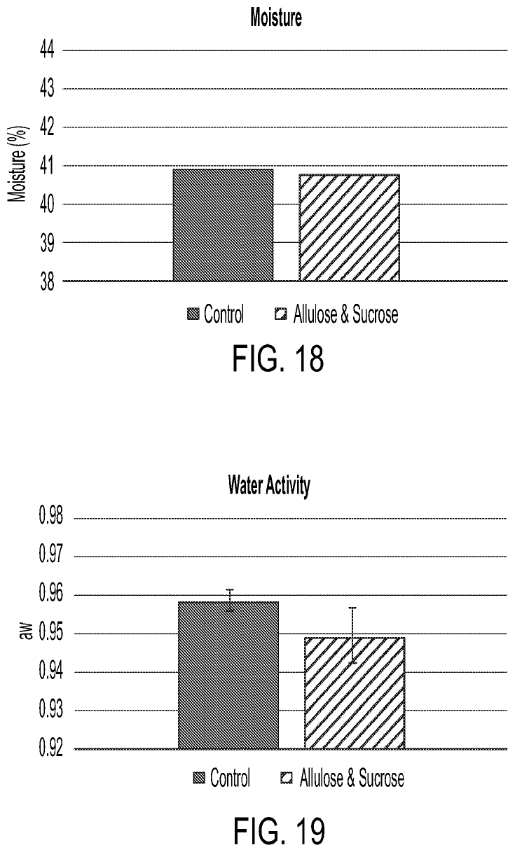

As shown in FIG. 13 control (sucrose-only) and allulose+sucrose bread exhibited similarity in visual appearance, including rise. The control and allulose+sucrose breads also displayed similar volume (FIG. 14), firmness (FIG. 15), crumb color (FIG. 16), and crust color (FIG. 17). However, the allulose-based bread exhibited significantly reduced volume compared to the control bread, indicating a failure to rise (FIG. 14). The allulose+sucrose bread and control bread also exhibited similar moisture content (FIG. 18) and water activity (FIG. 19). These results suggest that, in the allulose-based gluten-free bread, the yeast were unable to utilize a substrate for fermentation during the proofing process in the absence of sucrose, resulting in a failed bread product. Accordingly, allulose could not be used as a complete replacement for sucrose in the preparation of a gluten-free bread loaf.

### EXAMPLE 4. EFFECT OF SUGAR REDUCTION IN AN ALLULOSE-BASED GLUTEN-FREE BREAD FORMULATION

The present Example illustrates the effect of reducing the sucrose content of an allulose-based gluten-free bread formulation, in order to determine the minimum sucrose content required for production of an adequate gluten-free bread product. As discussed above, unlike sucrose, allulose is a nonfermentable substrate. Yeast typically ferments sucrose during the proofing process. Gluten-free flour typically comprises predominantly starches that are nonfermentable. It was thus hypothesized that, in the absence of sucrose and the presence of allulose, the yeast would not have access to sufficient fermentable substrate for fermentation during proofing, resulting in a failed final gluten-free bread product. However, the inclusion of small amounts of sucrose could potentially prevent such a failure of bread production.

Control gluten-free bread formulation (comprising 3.41% sucrose), and allulose-containing gluten-free bread formulations with various low levels of sucrose (1.25%, 0.75%, and 0.5% sucrose) were prepared using the ingredients at the indicated amounts shown in Table 3.

TABLE 3
Gluten-free bread formulations with varied sucrose content

| | | 1.25% | 0.75% | 0.5% |
|---|---|---|---|---|
| Ingredients (%) | Control | Sucrose | Sucrose | Sucrose |
| Precisa ® Bake | 41.17% | 41.17% | 41.17% | 41.17% |
| GF Starch | | | | |
| Psyllium Husk | 2.4% | 2.4% | 2.4% | 2.4% |
| Sucrose | 3.41% | 1.25% | 0.75% | 0.5% |
| Allulose | 0% | 5.09% | 5.74% | 6.08% |
| Egg White | 1.54% | 154% | 1.54% | 1.54% |
| Powder | | | | |
| Salt | 0.84% | 0.84% | 0.84% | 0.84% |
| HPMC | 1.67% | 1.67% | 1.67% | 1.67% |
| HFCS | 2.1% | 0% | 0% | 0% |
| Canola Oil | 5.02% | 5.02% | 5.02% | 5.02% |
| Water | 41.18% | 4.035% | 40.2% | 40.11% |
| Yeast, instant | 0.67% | 0.67% | 0.67% | 0.67% |
| Total | 100% | 100% | 100% | 100% |

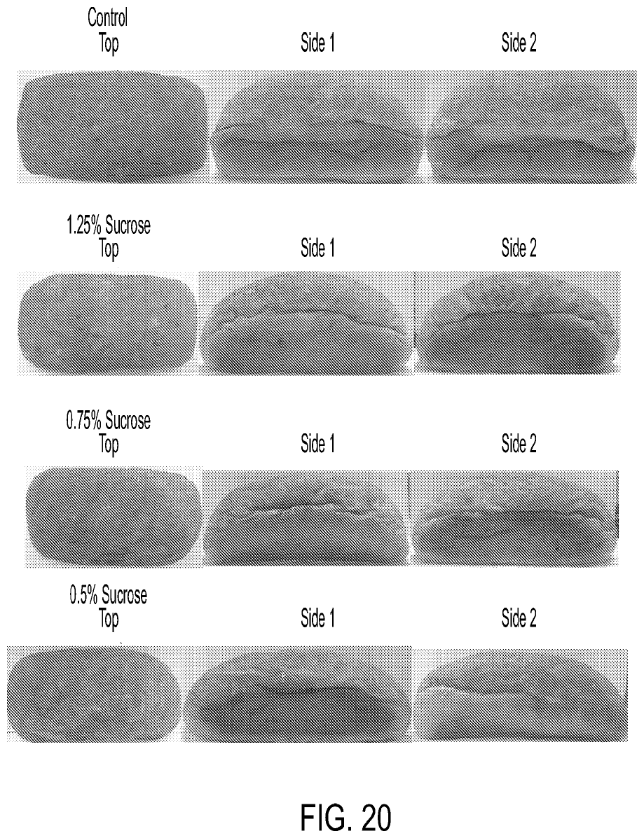

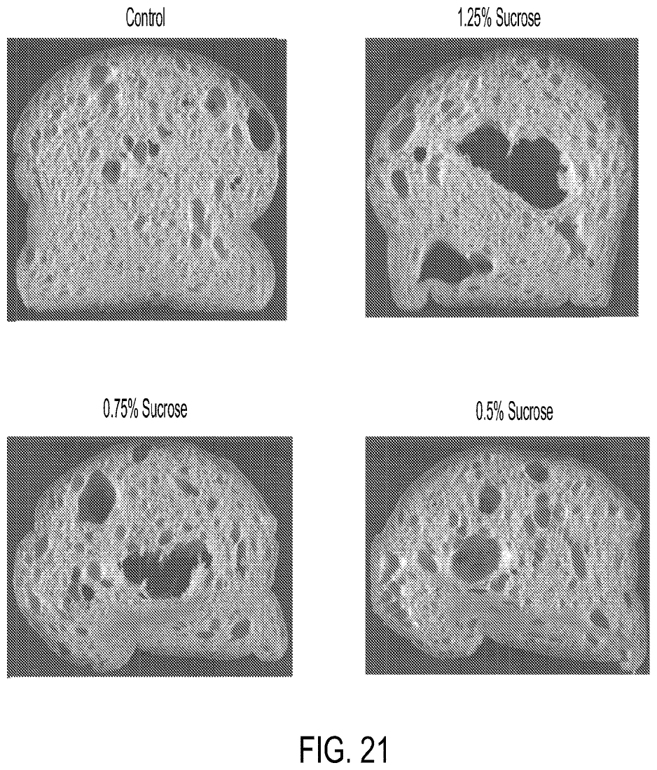

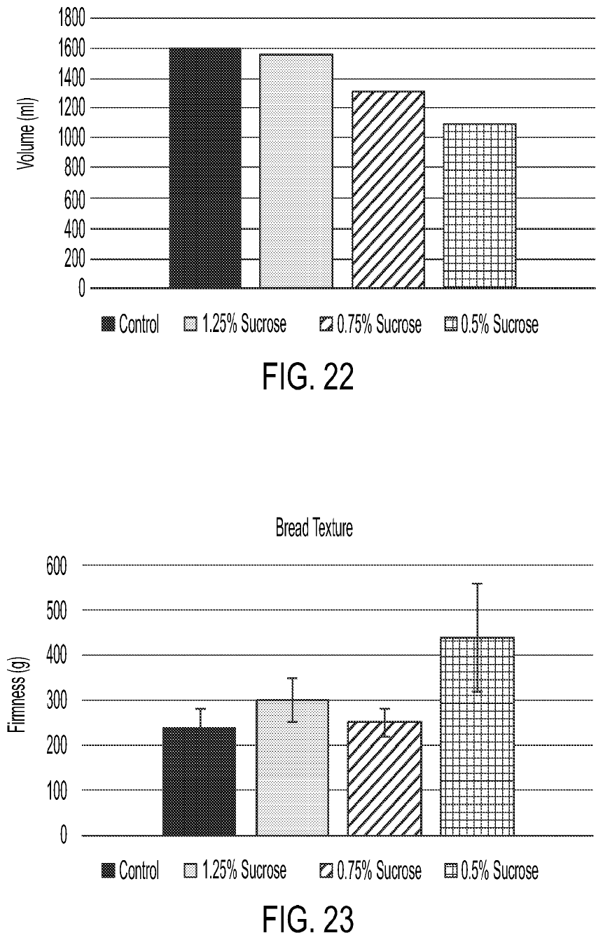

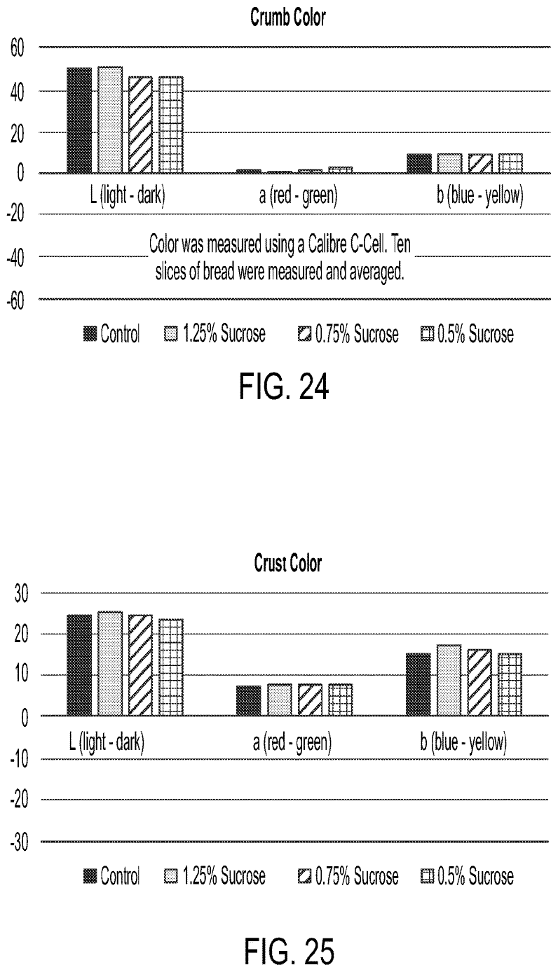

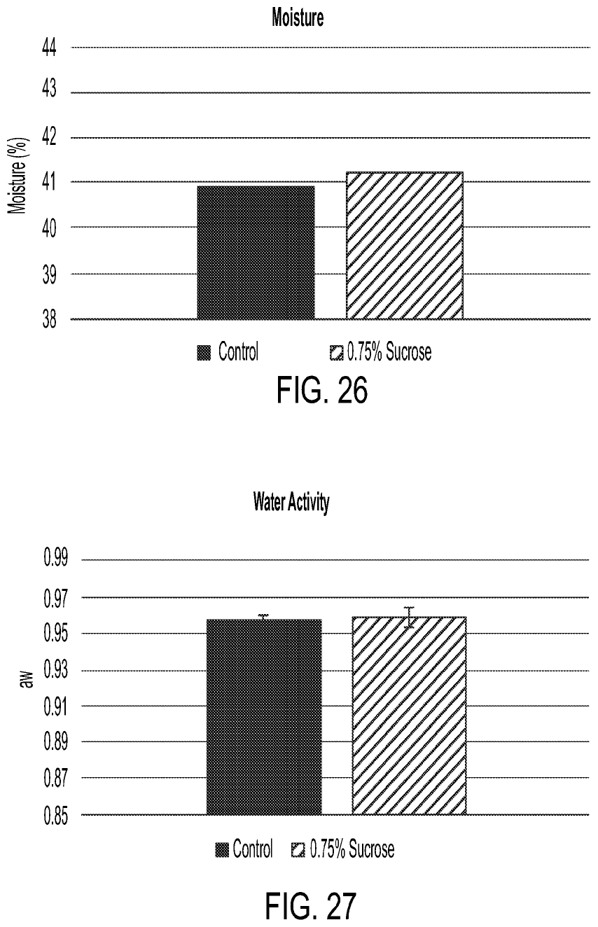

As shown in FIG. 20 control (sucrose-only) and allulose+low-sucrose bread exhibited similarity in visual appearance. As shown in FIG. 21, as sucrose content was reduced, the bread was less-cooked, as evidenced by the raw dough near the bottom of the loaf. As the sucrose content of the allulose+low-sucrose breads decreased, volume decreased (FIG. 22), firmness increased (FIG. 23), crumb color darkened (FIG. 24), and crust color darkened (FIG. 25). The allulose+0.75%-sucrose bread and control bread also exhibited similar moisture content (FIG. 26) and water activity (FIG. 27). These results showed that, the 0.75% and 0.5% sucrose samples did not bake properly, however, a sucrose content of 1.25% was sufficient to produce a bread product with similar characteristics to those observed in the control bread. Accordingly, an allulose-based, reduced-sucrose gluten-free bread product was successfully achieved using the above-described methods and formulations.

### EXAMPLE 5. EFFECT OF SUGAR TYPE IN AN ALLULOSE-BASED REDUCED-SUGAR GLUTEN-FREE BREAD FORMULATION

The present Example illustrates the effect of different sugar types in an allulose-based, reduced-sugar, gluten-free bread formulation. As discussed above, unlike sucrose, allulose is a nonfermentable substrate. However, yeast able to ferment dextrose and HFCS. Gluten-free flour typically comprises predominantly starches that are nonfermentable. It was thus hypothesized that, in the absence of sucrose and the presence of allulose and small amounts of other non-sucrose sugars and gluten-free flour, the yeast would utilize the non-sucrose sugars during the proofing process, providing a final bread product with similar characteristics to those observed in sucrose-containing bread.

Control gluten-free bread formulation (comprising 3.41% sucrose), and allulose-containing, reduced sugar (1.25%) gluten-free bread formulations with various sugar types (sucrose, dextrose, and high-fructose corn syrup (HFCS)) were prepared using the ingredients at the indicated amounts shown in Table 4.

TABLE 4
Low-sugar gluten-free bread formulations with varied sugar type

| | | 1.25% | 1.25% | 1.25% |
|---|---|---|---|---|
| Ingredients (%) | Control | Sucrose | Dextrose | HFCS |
| Precisa Bake ® GF | 41.17% | 41.17% | 41.17% | 41.17% |
| Starch | | | | |
| Psyllium Husk | 2.4% | 2.4% | 2.4% | 2.4% |
| Sucrose | 3.41% | 1.25% | 0% | 0% |
| Dextrose | 0% | 0% | 1.25% | 0% |
| Allulose | 0% | 5.09% | 5.09% | 5.09% |
| Egg White Powder | 1.54% | 1.54% | 1.54% | 1.54% |
| Salt | 0.84% | 0.84% | 0.84% | 0.84% |
| HPMC | 1.67% | 1.67% | 1.67% | 1.67% |
| HFCS 55 (77 solids) | 2.1% | 0% | 0% | 1.62% |
| Canola Oil | 5.02% | 5.02% | 5.02% | 5.02% |
| Water | 41.18% | 40.35% | 40.35% | 39.98% |
| Yeast, instant | 0.67% | 0.67% | 0.67% | 0.67% |
| Total | 100% | 100% | 100% | 100% |

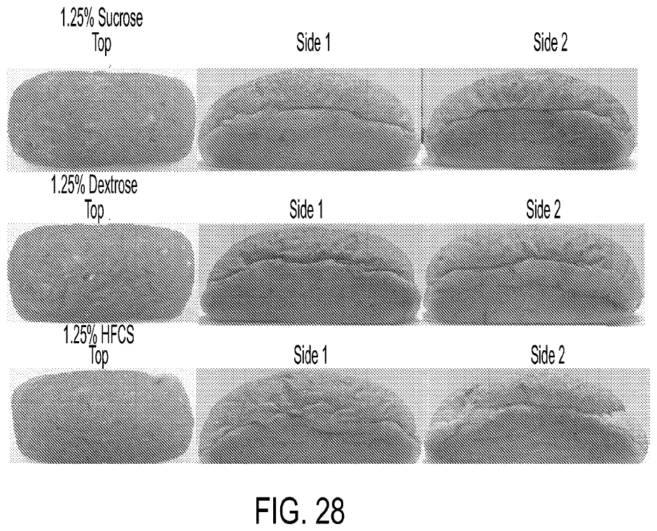

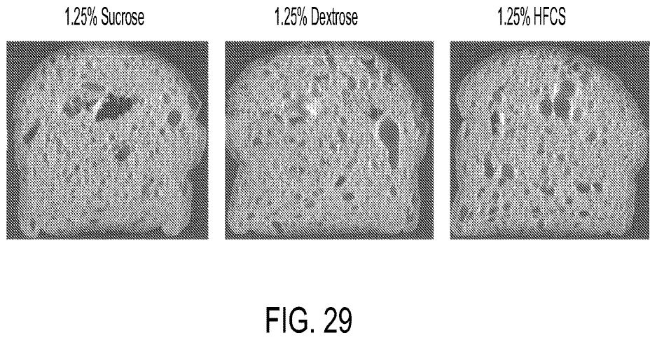

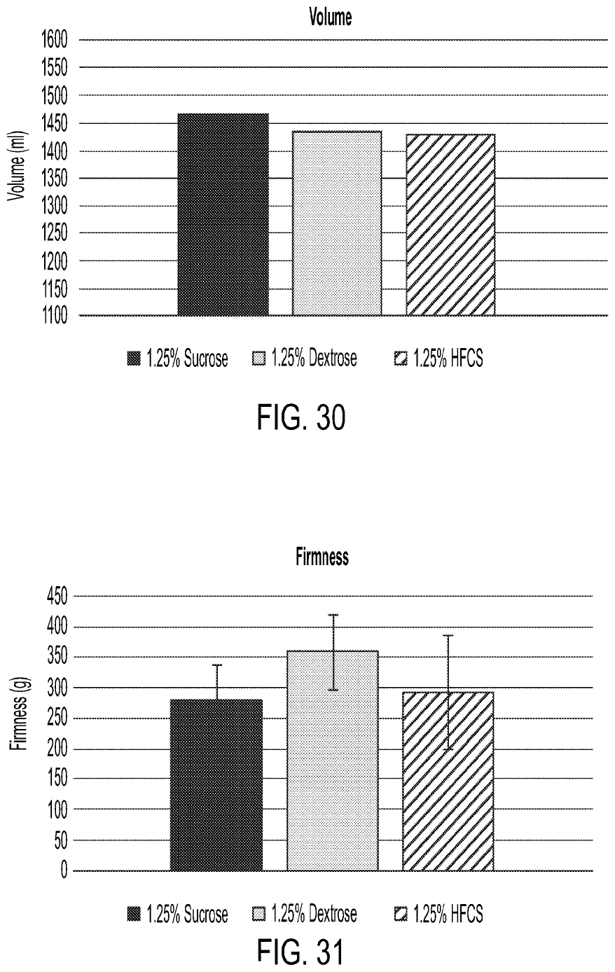

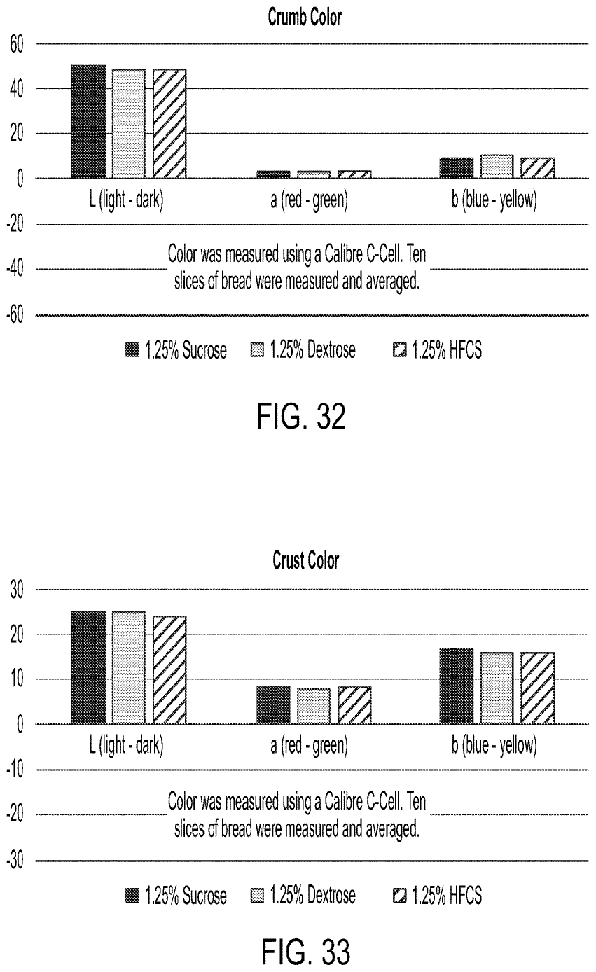

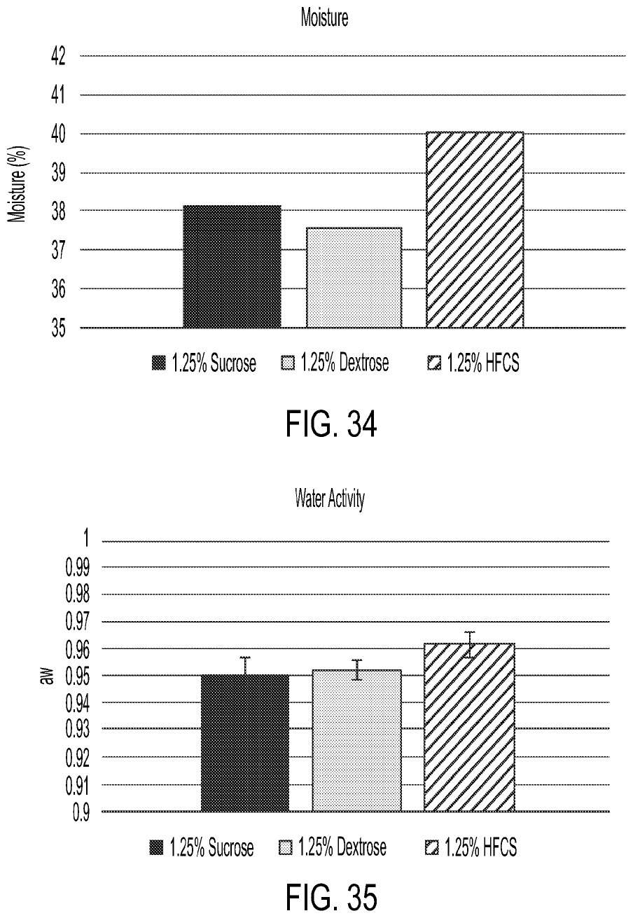

As shown in FIG. 28 and FIG. 29, sucrose-, dextrose-, and HFCS-based bread exhibited similarity in visual appearance. The volume (FIG. 30), firmness (FIG. 31), crumb color (FIG. 32), and crust color (FIG. 33) were similar across loaves with various sugar types. The HFCS-based bread exhibited slightly higher similar moisture content (FIG. 34) and water activity (FIG. 35), than the sucrose-based bread and the dextrose-based bread. These results confirmed that low levels of dextrose or HFCS can be used in place of sucrose to produce a low-sugar gluten-free bread product.

1. A gluten-free bread product comprising:
gluten-free flour;
about 0.5 wt % to about 10 wt % of a rare sugar; and
about 0.5 wt % to about 2 wt % of a fermentable monosaccharide or disaccharide, or syrup.

2. The gluten-free bread product of claim 1, wherein the gluten-free flour comprises non-fermentable gluten-free starches.

3. The gluten-free bread product of claim 1, wherein the rare sugar is selected from the group consisting of allulose, tagatose, sorbose, apiose, allose, altrose, melezitose, L-ribose, L-fucose, L-arabinose, D-turanose, and D-leucrose.

4. The gluten-free bread product of claim 1, wherein the rare sugar is allulose.

5. The gluten-free bread product of claim 1, wherein the rare sugar is present at a concentration of about 5 wt %.

6. The gluten-free bread product of claim 1, wherein the fermentable monosaccharide or disaccharide, or syrup is selected from the group consisting of sucrose, dextrose, and high-fructose corn syrup.

7. The gluten-free bread product of claim 1, wherein the fermentable monosaccharide or disaccharide, or syrup is sucrose.

8. The gluten-free bread product of claim 1, wherein the fermentable monosaccharide or disaccharide, or syrup is present at a concentration of about 1.25 wt %.

9. The gluten-free bread product of claim 1, further comprising one or more of psyllium husk, egg white, salt, hydroxypropyl methylcellulose (HPMC), canola oil, yeast, and water.

10. The gluten-free bread product of claim 1, further comprising a high potency sweetener (HPS).

11. The gluten-free bread product of claim 1, further comprising a HPS at a concentration of about 10 ppm to about 2000 ppm.
